(19) United States
(12) Patent Application Publication
(10) Pub. No.: US 2017/0176951 A1
(43) Pub. Date: Jun. 22, 2017

(54) MULTI-EYE ANALOG SMART TIMEKEEPING APPARATUS AND METHOD OF MAKING A DISPLAY PANEL

(71) Applicant: SILVERPLUS, INC., Irvine, CA (US)

(72) Inventors: Chih-Chang HSIEH, Irvine, CA (US); Te-Hsiu CHIU, Taipei City (TW); Ming-Yish CHEN, Taipei City (TW)

(73) Assignee: SILVERPLUS, INC.

(21) Appl. No.: 14/975,898

(22) Filed: Dec. 21, 2015

(51) Int. Cl. G04G 9/00

(52) U.S. Cl. CPC G04G 9/0064

(57) ABSTRACT

The present disclosure discloses a multi-eye analog smart timekeeping apparatus, comprising: a dial, comprising a dial substrate comprising a plurality of view regions; an arm positioned above the dial; a display panel positioned below the dial and comprising a plurality of display regions, each of the display regions corresponding to one of at least two of the view regions; and a shaft connected to the arm and being through the dial and the display panel. The present disclosure also discloses a method of making a display panel that may be used with the timekeeping apparatus, comprising: providing a first substrate comprising a first area; forming a display layer on the first substrate outside the first area; applying encapsulation material on the first area and around the display layer; sealing the display layer between the first substrate and a second substrate; and drilling a hole in the first area, wherein a size of the hole is smaller than a size of the first area.

### TECHNICAL FIELD

The present disclosure generally relates to timekeeping devices, and, more specifically to multi-eye smart watches with analog arms and related manufacturing methods.

### BACKGROUND

Watches are well-known timekeeping devices. Traditional watches are made of mechanical components only, such as movements, wheels, shafts, springs, dials and arms. Such watches require delicate craftsmanship and are often worn to demonstrate the social-economic status and refined taste of the wearers. Although offering a sense of luxury and prestige, purely mechanical watches are less accurate and more limited in functionalities compared to other types of watches, which are composed of technologically advanced components, such as vibrating quartz crystals and integrated circuits.

Efforts have been made to enhance the functionalities of purely mechanical watches. As an example of the results of such efforts, FIGS. 1A and 1B illustrate a watch 1 with a single view region 11 (normally referred to as “single-eye”). The watch 1 has a mechanical look because of the dial, the crown and the arms connected to a movement 12 by a shaft in the center. A small rectangular display panel 13 whose location corresponds to the single view region is placed beneath the dial. It can be seen from FIG. 1B that the size and location of the display panel 13 are limited by the movement 12 and thus cannot be flexibly designed. The limited size and location of the display panel 13 often restricts the amount of information that can be displayed, hindering further expansion of digital functionalities.

An approach to provide more digital functionalities to a watch is to get rid of the clockwork and make the watch completely digital. Such a watch has no dial or arm, but has only a display panel. The display panel “displays” arms and a dial to mimic the appearance of a mechanical watch. However, such a mimicked appearance lacks the sense of luxury and prestige conveyed by the appearance of a traditional watch. Also, advanced digital functionalities may not appeal to watch customers who want a traditional look more than modern features.

One way to provide more digital features to a watch while preserving the traditional “look and feel” is to use multiple display panels beneath a dial with multiple view regions (normally referred to as “multi-eye”). However, as shown in the prior art watch in FIG. 1B, the size and location of the display panel 13 are limited by the movement 12. Additional display panels would still be limited by the movement. Moreover, the mechanical/electronic structures and the associated assembly processes must be redesigned whenever there is a change in the configuration of the view regions and/or display panels (e.g., number and size). Because of such inflexibility, it is costly to design and manufacture this kind of watch.

### SUMMARY OF INVENTION

Therefore, there is a need to address the abovementioned deficiencies of prior art watches.

According to an embodiment of the present disclosure, a timekeeping apparatus is provided. The timekeeping apparatus comprises a dial, an arm positioned above the dial, a display panel positioned below the dial, and a shaft connected to the arm and being through the dial and the display panel. The dial comprises a dial substrate that comprises a plurality of view regions. The display panel comprises a plurality of display regions, each of the display regions corresponding to one of at least two of the view regions. In some embodiments, the view regions may be windows or areas of materials that are different from the material of the dial substrate and have sufficient transparency in the materials of the view regions to allow the wearer to see things behind the view regions. In some embodiments, the timekeeping apparatus may be a watch.

The timekeeping apparatus according to an embodiment of the present disclosure provides more flexibility to the designers of watches having both a traditional appearance and enhanced digital functionality, particularly to more flexibility in the number, size, shape and location of view regions on the watch without undesirably increasing the number of electronic components or significantly increasing the complexity in integrating the mechanical and electronic parts of the watch. The wearer may simultaneously view different things from the display panel even though the display panel is behind the dial. It is also possible that some view regions may be traditional, e.g., providing a smaller clock with its arms and dials to indicate different time zones,

The configuration of the view regions (e.g., number, size, shape, location, color and material) may change rapidly to meet customer needs. Since the plurality of display regions of the watch of the present disclosure are provided by the same display panel rather than different, smaller display panels, watch designers do not have to redesign the final assembly every time the configuration of the view regions changes. Also, the integration of the mechanical and electronic components would be less complicated. These advantages could be very appealing to designers of traditional branded watches who would like to expand their product lines by offering dual-mode (mechanical/electronic) watches but fear the high costs in research and development and a possible low speed of time-to-market

Since the arms and dial of the watch may have a more traditional flair, the watch according to the embodiments of the present disclosure may appeal more to potential buyers who like enhanced digital features but prefer watches with visible mechanical components.

According to an embodiment of the present disclosure, the display panel of the watch has substantially the same size and shape as the dial.

Since the display panel has substantially the same size and shape as the dial, watch designers may choose to place view regions almost anywhere on the dial to meet their needs, in other words, watch designers may have maximum freedom in placing view regions on the dial. In some other embodiments, the display panel and the dial do not have to be the same in size or shape. Their sizes and/or shapes may be different to accommodate additional features on the display panel and/or the dial (e.g., positioning features that increase the overall mechanical reliability of the watch) and/or to allow room for other components of the watch (e.g., a bezel).

According to an embodiment of the present disclosure, the display regions of a single display panel are controllable independently from each other.

Consequently, the wearer is allowed to view different, independent information and/or use independent software applications (or apps) in different view regions. The display regions may be controlled by software, firmware, hardware or any suitable combination thereof. Independently controllable display regions that correspond to respective view regions on the dial of the watch allow the wearer to customize what to do with and what to see from each display region. For example, the wearer may simultaneously be notified of incoming SMS/instant messages, see the time in a time zone other than that indicated by the arms, and be guided by a (software or hardware implemented) compass. This degree of versatility makes for great convenience.

According to an embodiment of the present disclosure, the display panel of the watch comprises a matrix structure and a hole which the shaft goes through, and the hole does not affect the display capabilities of the matrix structure around the hole.

Matrix-structure display panels such as those based on liquid crystals, LED, OLED, organic luminescent materials, plasma cells and electronic ink, have high performance and are used in many modern digital devices. Thus, it could be advantageous to use these display panels in smart watches. However, they might be sensitive to even small amount of physical damage. Therefore, any damage to the electrodes of a pixel could prevent the areas surrounding the pixel from functioning properly. In addition, the display layer of a display panel should be in a vacuum state after sealing. Punching a hole in a traditional matrix-structure display panel would severely damage the panel, making it unable to function properly or even unusable. In contrast, the display panel according to an embodiment of the present disclosure comprises a hole whose existence does not affect the display capabilities of the matrix structure around the hole, which makes the display panel suitable for a watch with mechanical arms connected to a movement by a shaft through the hole. The mechanical arms can make the watch have the visual appeal of a traditional watch.

According to an embodiment of the present disclosure, the display panel further comprises at least one positioning feature on the boundary of the display panel. According to another embodiment of the present disclosure, the dial further comprises at least one positioning feature on the boundary of the dial.

Positioning features, such as notches that may receive corresponding protrusions/pillars on other components of the watch and protrusions that may fit into corresponding holes/notches/hollow areas of other components of the watch, would be useful in holding together all components of the watch more tightly, enhancing the mechanical reliability of the watch. Having positioning features on the boundary of the display panel and on the boundary of the dial could give more flexibility in designing the view regions of the dial and the display regions of the display panel. The positioning features may be two- or three-dimensional.

According to an embodiment of the present disclosure, the view regions are hollow. Hollow (i.e., empty) view regions allow light to go through and let the wearer see what is behind the view regions.

According to an embodiment of the present disclosure, the material of the view regions is different from that of the dial substrate, wherein the former is at least semi-transparent.

Cutting out or hollowing out portions from the dial substrate is not the only way to create view regions. They may also be created by making the material of some portions of the dial substrate (usually made of non-transparent material) become at least semi-transparent, such as plastic and glass. It is not necessary that view regions be made of completely transparent material. The degree of transparency may be chosen to fit different (e.g., visual) design needs. The view regions may also be colored to provide more visual effects, and it is known that plastic and glass may be colored. The top surface of the view regions may or may not be substantially coplanar with that of the dial substrate.

According to an embodiment of the present disclosure, at least one of the view regions may comprise an optical element, e.g., a lens, which may magnify or de-magnify the view below. Magnifying the display regions may help the user to see them more clearly and may be useful to users with reduced eyesight. Magnifying the display regions may also help create a greater variety of visual effects.

According to an embodiment of the present disclosure, a method for making a display panel that could be suitable for a smart watch with the aforementioned functionality and design flexibility is provided. The method comprises providing a first substrate comprising a first area, forming a display layer on the first substrate outside the first area, applying encapsulation material on the first area and around the display layer, sealing the display layer between the first substrate and a second substrate, and drilling a hole in the first area with the size of the hole being smaller than that of the first area. In some embodiments, the display layer may comprise an anode, a cathode, and display materials. In some embodiments, the display materials may be liquid crystal, LED, electroluminescent materials, plasma cells and/or electronic ink.

The display layer is in a vacuum state after sealing. The method according to the above embodiment, however, would not destroy the vacuum state during or after the drilling of the hole, because it is the encapsulation material (rather than the display layer/material/circuity) that is present in the area to be drilled. The encapsulation material in the area to be drilled maintains the vacuum state, and the absence of a display layer/material/circuitry in the area to be drilled may prevent the entire display layer (particularly the portion around the hole) from being damaged. The method according to the above embodiment would also remove the constraint on the placement of the display panel that would otherwise be required to accommodate the existence of the movement, which may mechanically drive the arms. The hole may also allow a shaft to go through for letting the movement to drive the arms. The arms can preserve the prestigious feel often attributed to mechanical watches.

The method according to the above embodiment may be adapted to provide more than one hole in the display panel.

According to an embodiment of the present disclosure, the first substrate further comprises at least one second area; the step of forming the display layer on the first substrate outside the first area further comprises forming the display layer on the first substrate outside the at least one second area; the step of applying encapsulation material on the first area and around the display layer further comprises applying encapsulation material on the at least one second area; and the step of drilling the hole in the first area further comprises drilling a hole in each of the at least one second area, a size of the hole in each of the at least one second area being smaller than a size of the respective second area.

Additional holes may be drilled for connecting additional shafts to additional arms or may reveal the mechanical structure behind the dial and the display panel, such as the movement, springs and wheels. Watches with a visible internal mechanical structure may allow wearers to see how the mechanical components of the watches work together and further enhance the sense of luxury.

According to an embodiment of the present disclosure, some of the additional holes may comprise an optical element therein, e.g., a lens, which may magnify or de-magnify the view behind the lens. Magnifying the mechanical structure behind the dial and/or the display panel may help the wearer to see the components more clearly and may further enhance the elegance of the watch.

### BRIEF DESCRIPTION OF THE DRAWINGS

FIGS. 1A and 1B illustrate a prior art watch.

FIG. 2A illustrates a top view of a multi-eye watch according to an embodiment of the present disclosure.

FIGS. 2B-2D illustrate partial cross-sectional views of a multi-eye watch according to an embodiment of the present disclosure.

FIG. 3 illustrates certain functionalities of a multi-eye watch according to an embodiment of the present disclosure.

FIGS. 4A and 4B respectively illustrate a top view and a cross-sectional view of a display panel according to an embodiment of the present disclosure.

FIG. 4C illustrates a top view of a display panel according to an embodiment of the present disclosure.

FIGS. 4D-4G illustrate cross-sectional views of the display layers according to some embodiments of the present disclosure,

FIGS. 5A and 5B illustrate a perspective view of a display panel according to some embodiments of the present disclosure.

FIG. 6 illustrates a perspective view of a seat according to an embodiment of the present disclosure.

FIG. 7 illustrates a perspective view of a dial according to an embodiment of the present disclosure.

FIG. 8 is a flow chart of a method of making a display panel according to an embodiment of the present disclosure.

FIG. 9 illustrates how various components of a watch according to an embodiment of the present disclosure are assembled.

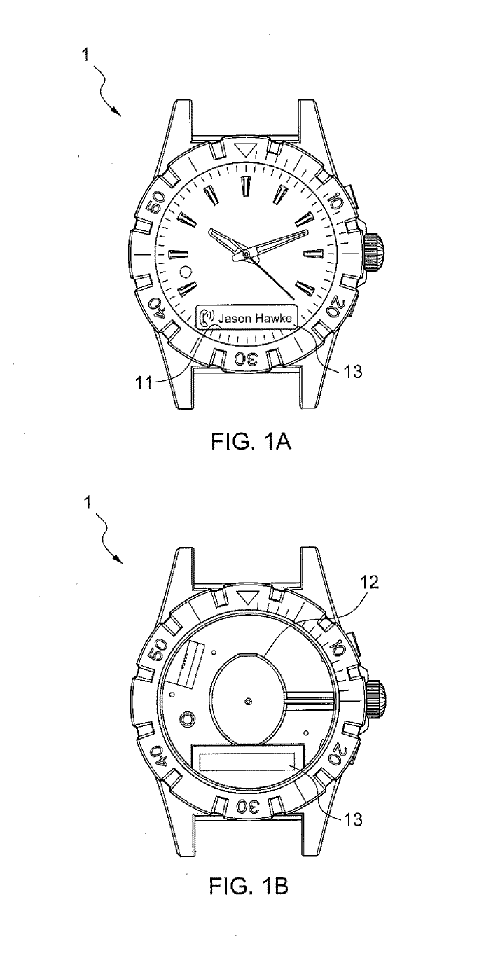

### DETAILED DESCRIPTION

The present disclosure can be better understood with reference to the description below and the accompanying drawings.

### Multi-Eye Watch

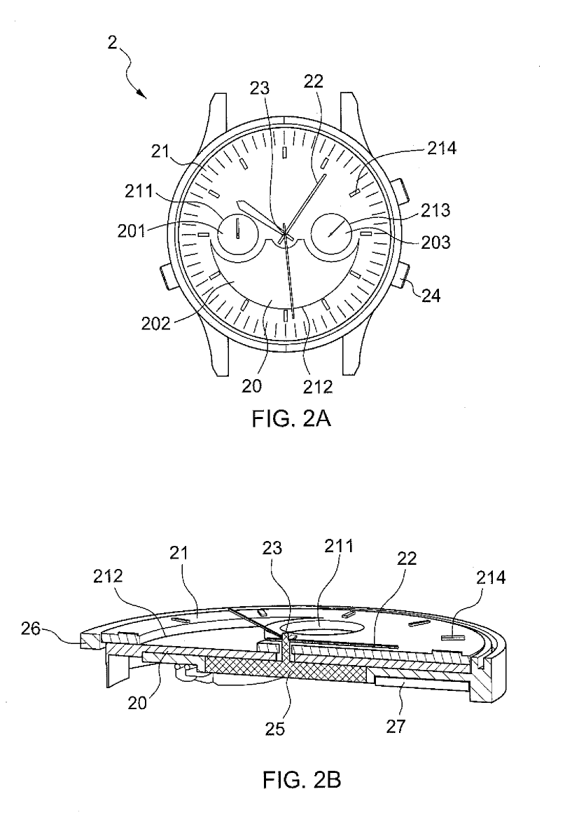

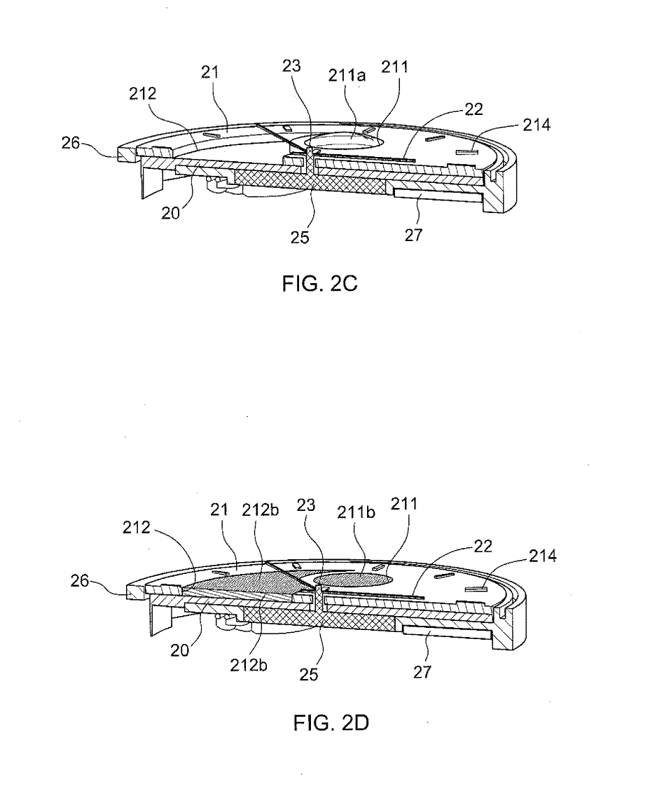

FIGS. 2A and 2B illustrate a watch 2 with multiple view regions (or “eyes”) 211-213 according to an embodiment of the present disclosure. The watch 2 may comprise a display panel 20, a dial 21 comprising a dial substrate, one or more arms 22, a shaft 23, one or more crowns 24, a movement 25, a seat 26 and a circuit board 27.

The display panel 20 may have one or more independently controllable display regions 201-203, which allow the wearer to view different, independent information and/or use independent software applications (or apps). Each of the display regions 201-203 may correspond to a view region. In the embodiment illustrated in FIG. 2A, the display regions 201-203 respectively correspond to the view regions 211-213. It should be noted that the number of view regions may be equal to or more than the number of display regions. In other words, some view regions may not need a corresponding display region; features other than the display panel, such as a compass and a small clock, may exist in these view regions.

In some embodiments, the display regions 201-203 may display a digital compass and/or a digital clock to mimic real ones. The display panel 20 may be an LCD panel, an LED panel, an OLED panel, an organic luminescent display panel, a plasma display panel or an electronic ink panel.

Using one display panel 20 to provide multiple display regions 201-203 has a clear advantage over using multiple smaller display panels because mechanical/electronic design and integration becomes much simpler. Only the individually controllable display regions 201-203 have to be changed, but no additional display panel is required. Another advantage is that the view regions 211-213 of the dial 21 may be changed (e.g., in size and location) without the need to redesign the watch assembly.

The dial 21 comprises a dial substrate in which the view regions 211-213 may be formed and to which the indices 214 are attached. The view regions 211-213 may be hollow to let the wearer see what is behind them. In some embodiments, the indices 214 may also be printed on the dial substrate and thus be substantially coplanar with the dial substrate. Although only three view regions 211-213 are shown in FIG. 2A, the number of view regions may be more than or less than three if needed.

In some embodiments, the display panel 20 and the dial 21 are substantially the same in size and shape. This may allow watch designers to have maximum freedom in placing view regions on the dial. Of course, the display panel 20 and the dial 21 may be different in size and/or shape to accommodate other features and/or components of the watch 2.

The arms 22 are connected to the shaft 23, which goes through the dial 21 and the display panel 20. The shaft 23 is also connected to the movement 25. The use of arms 22 on the dial 21 can help create the look of a traditional watch.

The crowns 24 may be used to control the arms 22. The crowns 24 may also be designed to control the display regions 201-203 and other features of the watch 2. In some embodiments, the crowns 24 may be in the form of a button. In some embodiments, the crowns 24 may be both rotatable and pressable and thus may act as both a traditional crown and a button.

The seat 26 accommodates other components of the watch. In some embodiments, the seat 26 may have additional features, such as positioning features (which are described below).

The circuit board 27 may comprise one or more digital circuits. In some embodiments, the circuit board 27 may comprise a generic microprocessor, a graphic processor, a power management circuit, sensors, a wireless communication module with various capabilities (e.g., Wi-Fi, Bluetooth, Bluetooth LE, cellular communication including 2G, 3G, 4G and beyond, NFC, and infrared), a display controller, and/or any other suitable components.

FIG. 2C illustrates another embodiment of the watch of the present disclosure. The components in FIG. 2C that are similar to those in FIG. 2B are labeled with the same reference numerals and will not be discussed in detail.

One difference between FIGS. 2B and 2C is the existence of an optical element in the view region 211, such as a lens 211a. The lens 211a may magnify or de-magnify the view behind the view region 211 to create a greater variety of visual effects. In some embodiments, the lens 211a is a magnifying element that may help the wearer see more clearly what is behind the view region 211.

FIG. 2D illustrates another embodiment of the watch of the present disclosure. The components in FIG. 2D that are similar to those in FIG. 2B are labeled with the same reference numerals and will not be elaborated in detail.

View regions 211-213 need not be hollow. In the embodiment illustrated in FIG. 2D, the materials 211b, 212b of the view regions 211, 212 may be different from the material of the dial substrate of the dial 21. The color and transparency of the materials 211b, 212b may be different from those of the material of the dial substrate of the dial 21. In some embodiments, the materials 211b, 212b may be at least semi-transparent to allow the wearer to see what is behind the view regions 211, 212. Although not shown in FIG. 2D, different materials may be used to form the view region 213. The top surface of the view regions 211, 212 with the materials 211b, 212b may be substantially coplanar with the dial substrate of the dial 21. The materials 211b, 212b may be plastic, glass or any other suitable materials. The materials 211b, 212b may have different colors and/or degrees of transparency. The materials 211b, 212b may create more visual effects.

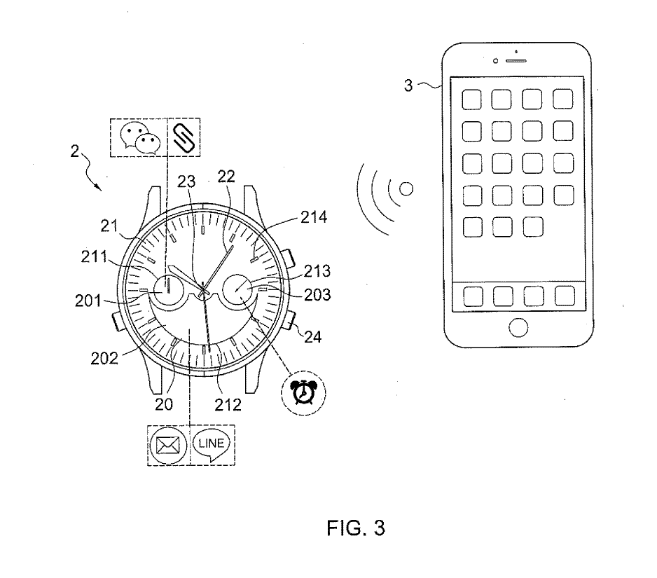

FIG. 3 illustrates a possible usage scenario of the watch 2, according to an embodiment of the present disclosure.

The display regions 201-203 may display information from different software applications or apps running on the watch 2 and/or received by the watch 2. Also, the watch 2 may, through the wireless communication module(s) on the circuit board 27 (not shown in FIG. 3), communicate with a device 3, which may be a mobile phone, a laptop, a desktop, a PDA, a hand-held gaming device, a wireless base station, or other devices with communication capabilities. In the embodiment illustrated in FIG. 3, the display region 201 displays information from an instant messaging application, the display region 202 displays information from a different instant messaging application (or some other application like e-mail), and the display region 203 displays information from an alarm clock application. The display regions 201-203 may display information from applications running on the watch 2, information from applications running on the device 3, or a combination of both. The wearer may, of course, choose the applications to be displayed in the display regions 201-203 and may decide how the watch 2 communicates with the device 3.

### Display Panel

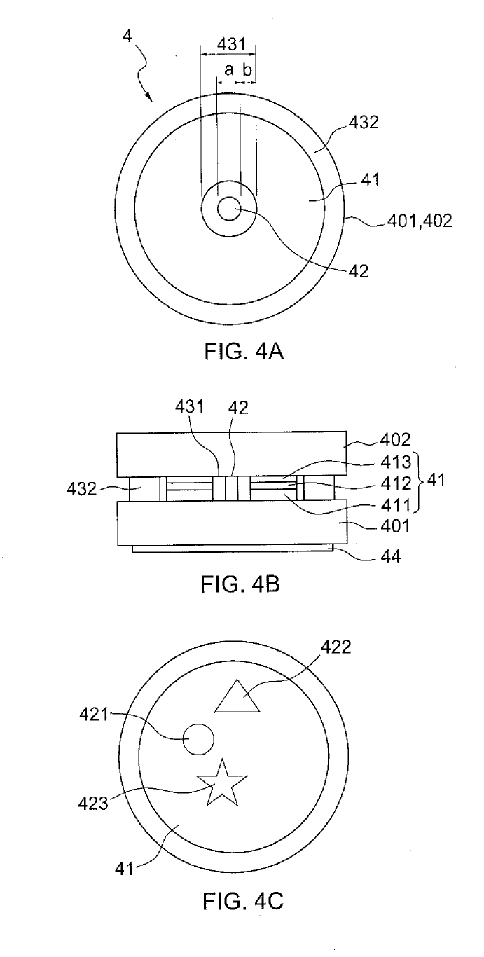

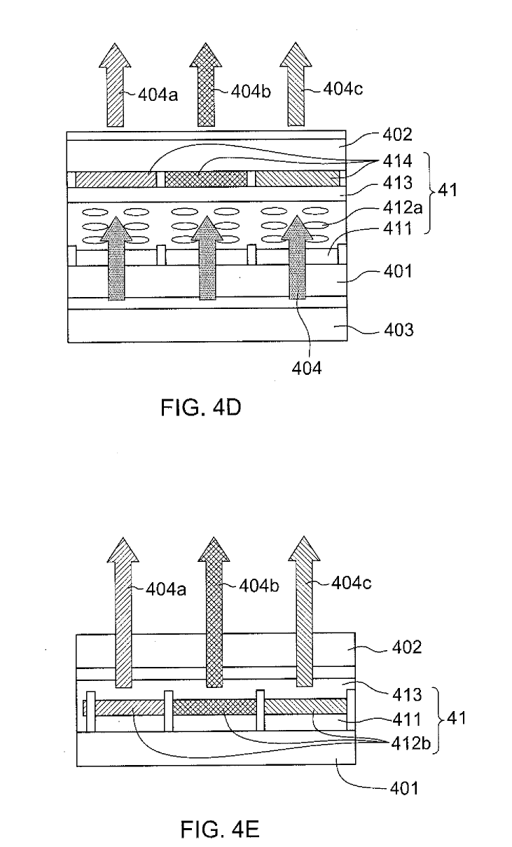

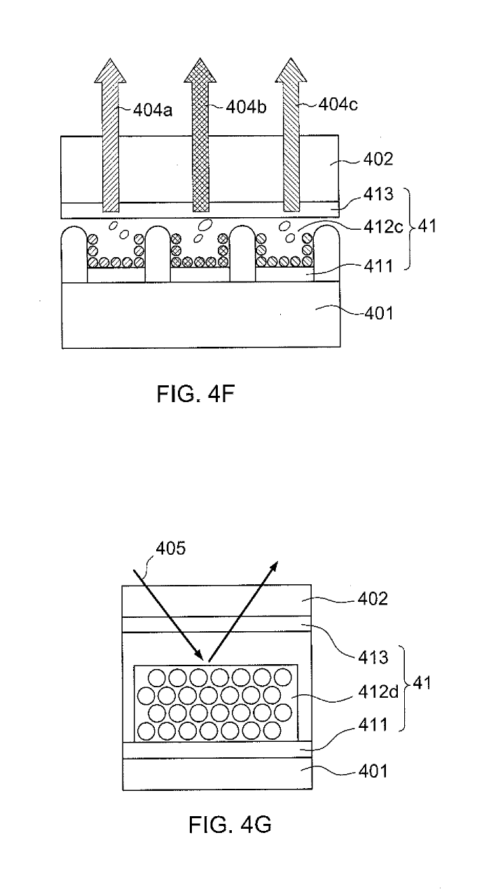

FIGS. 4A and 4B respectively illustrate a top view and a cross-sectional view of a display panel 4 according to an embodiment of the present disclosure.

The display panel 4 may comprise a first substrate 401, a second substrate 402, a display stack 41 between the substrates 401, 402, a hole 42 with diameter a, an inner encapsulation area 431 surrounded by the display stack 41, an outer encapsulation area 432, and other suitable components, such as a polarizer 44.

The substrates 401, 402 may be transparent, may provide mechanical support to the display panel 4, and may be made of any suitable materials known in the art, such as glass, resin and plastic. In some embodiments, the substrates 401, 402 may be at least semi-transparent and/or colored to have different visual effects.

The display stack 41 may comprise display materials and suitable control circuitry. In the embodiment illustrated in FIG. 4B, the display stack 41 may comprise a layer of first electrodes 411, a display layer 412, and a layer of second electrodes 413. In some embodiments, the first electrodes 411 are anodes (such as indium tin oxide, also known by its abbreviation, ITO), and the second electrodes 413 are cathodes. The display layer 412 may comprise a matrix structure.

The hole 42 would not affect the display capabilities of the display stack 41 around the hole 42. The hole 42 may also serve to let the shaft 23 (not shown in FIG. 4A or 4B) of the watch 2 go through the display panel 4. As explained above, the existence of the arms 22 driven by the shaft 23 and the movement 25 may create an appearance that has the sense of luxury and prestige usually conveyed by mechanical watches. The size and/or shape of the hole 42 can be adjusted to accommodate the shaft 23 that goes through the hole so as to increase mechanical reliability and manufacturing efficiency.

The encapsulation areas 431, 432 may serve to hold the substrates 401, 402 and the display stack 41 together. The encapsulation areas 431, 432 may also seal the space between them and thus maintain a vacuum state around the display stack 41. The display stack 41 may function more properly in the vacuum state and may be damaged if the vacuum state is not maintained properly. In some embodiments, the inner encapsulation area 431 may be in the shape of a concentric ring surrounding the hole 42 and having a width b.

FIG. 4C illustrates another embodiment of the display panel 4, in which more holes 421-423 may exist. The size and/or shape and/or location of the holes 421-423 may be different from each other and may be decided based on the needs of the watch designer. The holes 421-423 may allow one or more shafts to go through to drive more than one set of arms. The holes 421-423 may also allow the mechanical components (such as the movement, springs and wheels) behind the display panel 4 to be partially revealed. Such visual effects may further enhance the sense of luxury of the watch. In some embodiments, magnifying and/or demagnifying optical elements may exist in some of the holes 421-423.

FIGS. 4D-4G provide more details on different types of the display panel 4 according to different embodiments of the present disclosure.

In FIG. 4D, the display stack 41 comprises electrodes 411, 413 and liquid crystal materials 412a. A backlight 403 that may emit light 404 is below the first substrate 401. The liquid crystal materials 412a may allow the light 404 to pass or block it. The passed light may go through different optical elements 414 to generate light with different colors 404a-404c, such as red, green and blue.

In FIG. 4E, the display stack 41 comprises electrodes 411, 413 and electroluminescent materials 412b, which may be organic. The electroluminescent materials 412b, when properly stimulated, may generate light with different colors 404a-404c, such as red, green and blue.

In FIG. 4F, the display stack 41 comprises electrodes 411, 413 and plasma cells 412c to generate light with different colors 404a-404c (such as red, green and blue).

In FIG. 4G, the display stack 41 comprises electrodes 411, 413 and a pigment layer 412d with a plurality of transparent microcapsules, such as those used in E-Ink. The electrodes 411, 413 may control the movement of charged white/black pigments in the microcapsules so that light 405 may pass or be reflected, resulting in a white/black color.

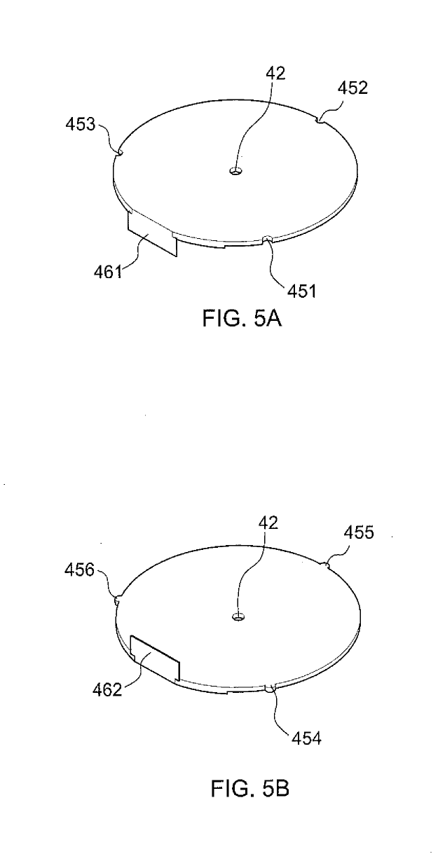

FIGS. 5A and 5B illustrate display panels with different positioning features according to some embodiments of the present disclosure.

In FIG. 5A, the display panel may comprise a hole 42 in the center and positioning features, such as notches 451-453 distributed on the perimeter of the display panel and a downward protrusion 461. The notches 451-453 may hold corresponding pillars on other components of the watch (such as the seat) so that the components of the watch may hold to each other more firmly, thereby increasing the mechanical stability of the watch. The protrusion 461 may fit into a hollow space in other components of the watch (such as the seat) and may help retain the proper position of the display panel

In FIG. 5B, the display panel may comprise a hole 42 in the center and positioning features, such as protrusions 454-456 distributed on the perimeter of the, display panel and an upward protrusion 462. The protrusions 454-456 may fit into corresponding notches on other components of the watch (such as the seat) so that the components of the watch may hold to each other more firmly, thereby increasing the mechanical stability of the watch.

The protrusion 462 may fit into a hollow space in other components of the watch (such as the dial) and may help retain the proper position of the display panel.

### Other Features

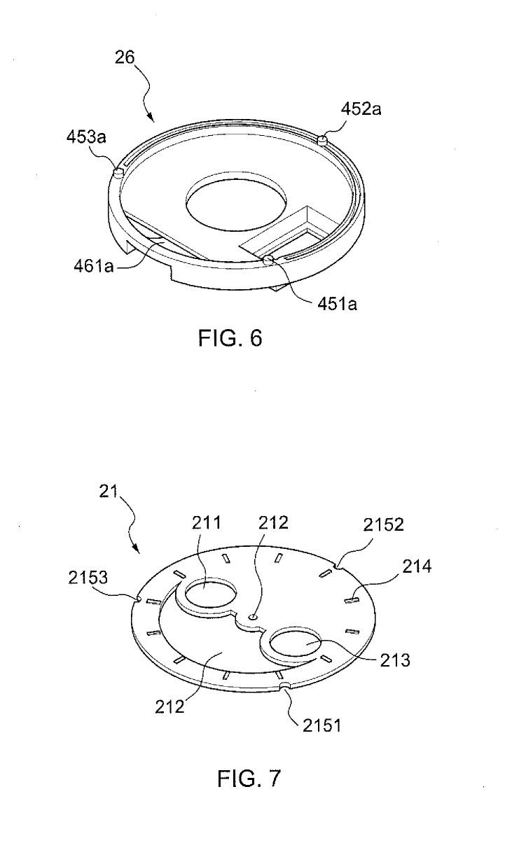

FIG. 6 illustrates a seat 26 according to an embodiment of the present disclosure. In addition to receiving the clockwork of the watch, the seat 26 may have additional positioning features, such as pillars 451a-453a and a hollow space 461a. In some embodiments, the pillars 451a-453a may respectively fit into the notches 451-453 of the display panel illustrated in FIG. 5A, and the hollow space 461a may receive the corresponding downward protrusion 461 illustrated in FIG. 5A. In some embodiments, the positioning features that match the pillars 451a-453a and the hollow space 461a may exist on other components of the watch.

FIG. 7 illustrates a dial 21 according to an embodiment of the present disclosure. In addition to the features mentioned above, the dial 21 may have additional positioning features, such as notches 2151-2153. In some embodiments, the notches 2151-2153 correspond to the pillars 451a-453a illustrated in FIG. 6. It should be noted that the pillars 451a-453a on the seat 26 may correspond to the notches 451-453 of the display panel, or the notches 2151-2153 of the dial 21, or both.

### Manufacturing Methods

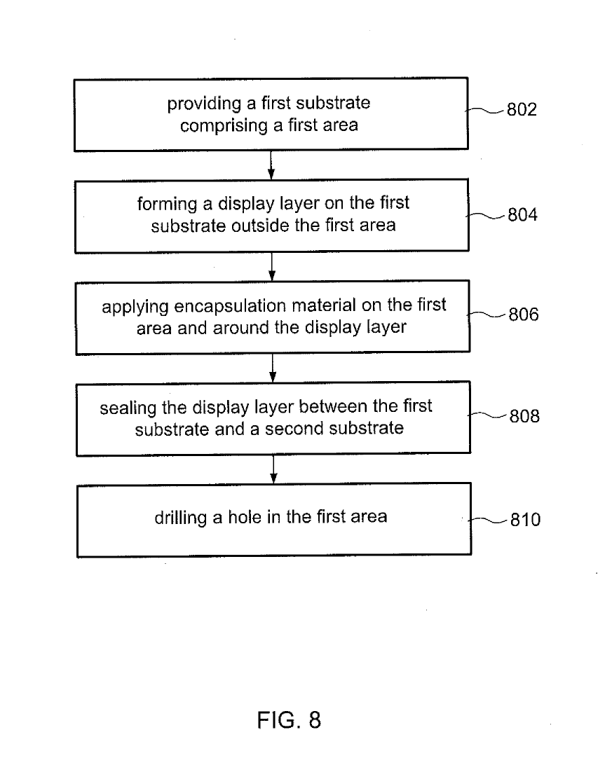

FIG. 8 illustrates a method of making a display panel according to an embodiment of the present disclosure, such as the display panel 4 illustrated in FIGS. 4A and 4B.

In step 802, a first substrate (such as the substrate 401) comprising a first area (such as an area that has the same size and shape as the inner encapsulation area 431) is provided. In step 804, a display layer (such as the display materials and/or associated control circuitry of the display stack 41) is formed on the first substrate outside the first area. In step 806, encapsulation material is applied on the first area and around the display layer (such as on the inner and outer encapsulation areas 431, 432). In step 808, the display layer is sealed between the first substrate carrying the display layer and a second substrate with the encapsulation material; note that the encapsulation material helps seal the two substrates and maintain a vacuum state of the display layer in between. In step 810, a hole is drilled in the first area. Although a hole is drilled in the first area, the functionality of the display layer is not affected because of the absence of the display layer in the first area. In addition, since the drilling is within the first area, on which encapsulation material has been applied, the vacuum state is maintained during and after the drilling.

In some embodiments, the first substrate further comprises at least one second area; the display layer is formed further outside the at least one second area; the encapsulation material is further applied on the at least one second area; and a hole is further drilled in each of the at least one second area. In some embodiments, the size of the hole in each of the at least one second area is smaller than the size of the respective second area. Consequently, more than one hole may be formed on the display panel (such as the display panel illustrated in FIG. 4C).

In some embodiments, a magnifying element, such as a lens, may be optionally placed in the hole of each of at least one of the at least one second area to provide different optical/visual effects.

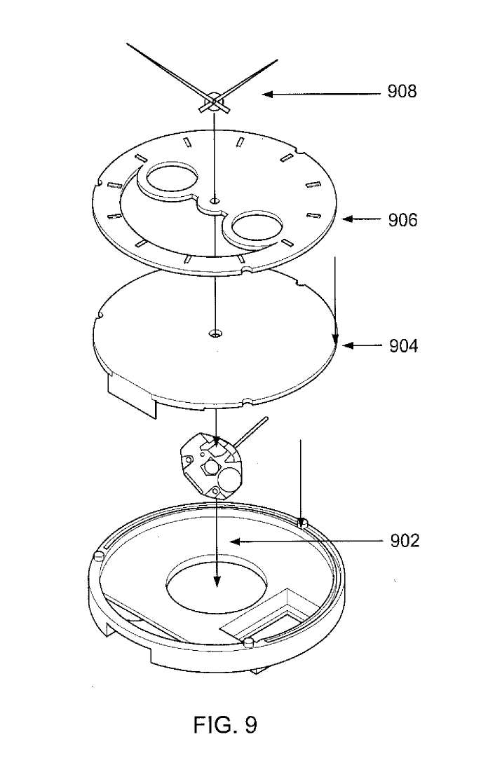

FIG. 9 illustrates how a watch according to an embodiment of the present disclosure is assembled. In step 902, a movement is placed on a seat; other components, such as a circuit board and other components of the clockwork, may also be placed on the seat. In step 904, the display panel is assembled; the display panel may optionally have notches and a downward protrusion that respectively correspond to the pillars and hollow space on the seat for better fitting. In step 906, the dial is assembled; the dial may optionally have notches that correspond to the pillars on the seat for better fitting. In step 908, a shaft and arms are connected to the movement. Other components, such as a bezel and watch bands, may also be provided.

Specific components of a multi-eye analog smart watch and related manufacturing methods have been described. It should, however, be apparent to those skilled in the art that many more modifications besides those already described are possible without departing from the inventive concepts herein. The inventive subject matter, therefore, is not to be restricted except in the spirit of the present disclosure. Moreover, in interpreting the present disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

### LIST OF REFERENCE SYMBOLS

1 watch
11 view region
12 movement
13 display panel
2 watch
20 display panel
201 display region
202 display region
203 display region
21 dial
211 view region
211a lens
211b different material
212 view region
212b different material
213 view region
214 index
2151 notch
2152 notch
2153 notch
22 arm
23 shaft
24 crown
25 movement
26 seat
27 circuit board
3 device
4 display panel
401 first substrate
402 second substrate
403 backlight
404 light
404a red light
404b green light
404c blue light
405 light
41 display stack
411 first electrode
412 display layer
412a liquid crystal materials
412b electroluminescent materials
412c plasma cells
412d pigment layer
413 second electrode
42 hole
421 hole
422 hole
423 hole
431 inner encapsulation area
432 outer encapsulation area
a diameter
b width
44 polarizer
451 notch
452 notch
453 notch
451a pillar
452a pillar
453a pillar
454 protrusion
455 protrusion
456 protrusion
461 protrusion
461a hollow space
462 protrusion
8 flow chart
802 step
804 step
806 step
808 step
810 step
902 step
904 step
906 step
908 step

1. A timekeeping apparatus, comprising:
a dial, comprising a dial substrate comprising a plurality of view regions;
an arm positioned above the dial;
a display panel positioned below the dial and comprising a plurality of display regions, each of the display regions corresponding to one of at least two of the view regions; and
a shaft connected to the arm and being through the dial and the display panel.

2. The apparatus of claim 1, wherein the display panel is substantially the same size and shape as the dial.

3. The apparatus of claim 1, wherein the display regions are controllable independently from each other.

4. The apparatus of claim 1, wherein the display panel comprises a matrix structure, wherein the display panel comprises a hole which the shaft goes through, and wherein the existence of the hole does not affect the display capabilities of the matrix structure around the hole.

5. The apparatus of claim 1, wherein the display panel further comprises at least one positioning feature on a boundary of the display panel.

6. The apparatus of claim 1, wherein the dial further comprises at least one positioning feature on a boundary of the dial.

7. The apparatus of claim 1, wherein the view regions are hollow.

8. The apparatus of claim 1, wherein a material of the view regions is different from a material of the dial substrate, and wherein the material of the view regions is at least semi-transparent.

9. The apparatus of claim 8, wherein at least one of the view regions comprises a magnifying element.

10. A method of making a display panel, comprising:
providing a first substrate comprising a first area;
forming a display layer on the first substrate outside the first area;
applying encapsulation material on the first area and around the display layer;
sealing the display layer between the first substrate and a second substrate; and
drilling a hole in the first area,
wherein a size of the hole is smaller than a size of the first area.

11. The method of claim 10, wherein:
the first substrate further comprises at least one second area;
the step of forming the display layer on the first substrate outside the first area further comprises forming the display layer on the first substrate outside the at least one second area;
the step of applying encapsulation material on the first area and around the display layer further comprises applying encapsulation material on the at least one second area;
the step of drilling the hole in the first area further comprises drilling a hole in each of the at least one second area, a size of the hole in each of the at least one second area being smaller than a size of the respective second area.

12. The method of claim 11, further comprising forming a magnifying element in the hole of each of at least one of the at least one second area.
